(19) United States
(12) Patent Application Publication
(10) Pub. No.: US 2013/0336500 A1
(43) Pub. Date: Dec. 19, 2013

(54) SIGNAL PROCESSING APPARATUS AND SIGNAL PROCESSING METHOD

(71) Applicant: KABUSHIKI KAISHA TOSHIBA, Tokyo (JP)

(72) Inventor: Takashi Sudo, Fuchu-shi (JP)

(73) Assignee: KABUSHIKI KAISHA TOSHIBA, Tokyo (JP)

(21) Appl. No.: 13/778,429

(22) Filed: Feb. 27, 2013

(30) Foreign Application Priority Data
Jun. 19, 2012 (JP) 2012-138184

(51) Int. Cl. G10K 11/00

(52) U.S. Cl. CPC G10K 11/002
USPC 381/94.1

(57) ABSTRACT

One embodiment provides a signal processing apparatus, including: a speaker; a vibration sensor; and a controller. The speaker is configured to output a sound. The vibration sensor is configured to detect a vibration that is caused by a solid propagation of the sound from the speaker, and to output a reference signal based on the detected variation. The controller is configured to perform a noise suppress control which suppresses a noise due to the vibration using the reference signal.

### CROSS-REFERENCE TO RELATED APPLICATION(S)

This application claims priority/priorities from Japanese Patent Application No. 2012-138184 filed on Jun. 19, 2012, the entire contents of which are incorporated herein by reference.

### FIELD

Embodiments described herein relate generally to a signal processing apparatus and a signal processing method.

### BACKGROUND

Conventionally, a disturbance component such as a noise component or an echo component which is contained in an audio signal is reduced by correcting the audio signal with a noise canceller, an echo canceller, or the like using a DSP (digital signal processor) or the like.

In particular, among such electronic apparatus as PDAs (personal digital assistants) and cell phones are ones in which noise introduced into an apparatus which is gripped by a user or attached to something is detected and a countermeasure is taken in a direction in which the apparatus is affected.

For example, there is known a method (linear acoustic echo canceller) for eliminating acoustic echo due to air propagation of sound from a speaker. Further, there is known a method (nonlinear acoustic echo canceller) for eliminating acoustic echo (nonlinear component) due to speaker vibration, for example. Still further, there is know a method (double microphone acoustic echo canceller) for eliminating acoustic echo due to air propagation of sound from a speaker using an adaptive filter which uses, as a reference signal, sound that is emitted from the speaker and goes around and reaches microphones.

However, none of the above methods directly take into consideration sound that is emitted from a speaker and goes around and reaches a microphone through body vibration (solid propagation sound) or an echo path variation due to apparatus body motion that is caused by a user action.

That is, although a technique is desired which can suppress echo and noise that are introduced into a microphone through solid propagation (i.e., propagation through an apparatus body) of vibration that originates from a speaker, no means capable of satisfying that desire seems to be known.

### BRIEF DESCRIPTION OF DRAWINGS

A general architecture that implements the various features of the present invention will now be described with reference to the drawings. The drawings and the associated descriptions are provided to illustrate embodiments and not to limit the scope of the present invention.

FIG. 1 schematically shows an appearance of an electronic apparatus according to a first embodiment.

FIG. 2 is a block diagram showing an example hardware configuration of the electronic apparatus according to the first embodiment.

FIG. 3 is a block diagram schematically showing a functional configuration of the electronic apparatus according to the first embodiment.

FIG. 4 is a block diagram schematically showing another functional configuration of the electronic apparatus according to the first embodiment.

FIG. 5 shows the configuration of an echo/noise suppressing section 20A used in the first embodiment.

FIG. 6 is a block diagram showing a detailed configuration of a first echo suppressing section 20A1 used in the first embodiment.

FIG. 7 is a block diagram showing a detailed configuration of a second echo suppressing section 20A2 used in the first embodiment.

FIG. 8 is a flowchart of an example process which is executed by the electronic apparatus according to the first embodiment.

FIG. 9 is a block diagram showing a functional configuration of an electronic apparatus according to a second embodiment.

FIG. 10 is a block diagram showing another functional configuration of the electronic apparatus according to the second embodiment.

FIG. 11 shows a configuration which relates to a feedback canceling section 35 and a feedback cancellation control section 36 used in the second embodiment.

### DETAILED DESCRIPTION

One embodiment provides a signal processing apparatus, including: a speaker; a vibration sensor; and a controller. The speaker is configured to output a sound. The vibration sensor is configured to detect a vibration that is caused by a solid propagation of the sound from the speaker, and to output a reference signal based on the detected variation. The controller is configured to perform a noise suppress control which suppresses a noise due to the vibration using the reference signal.

Embodiments will be hereinafter described.

### Embodiment 1

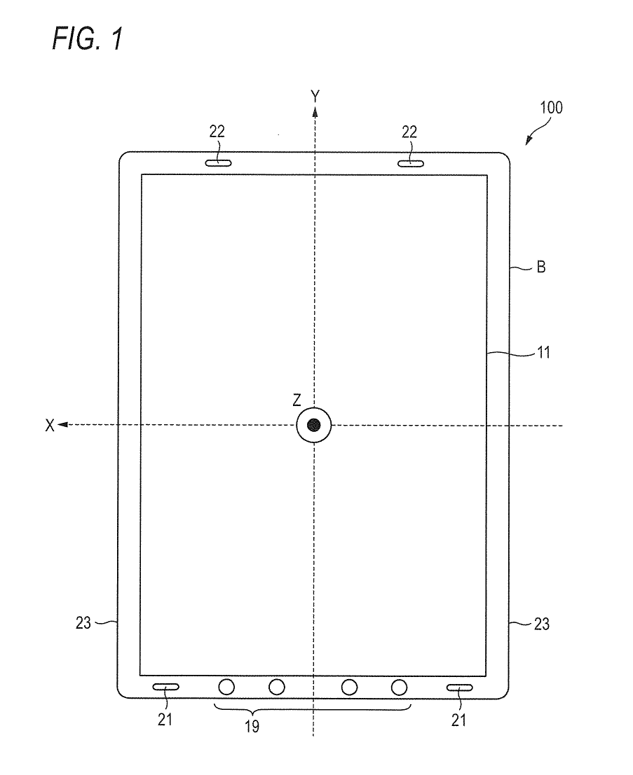

An electronic apparatus 100 and its control method according to a first embodiment will be described in detail with reference to FIGS. 1-8. The electronic apparatus 100 according to the first embodiment functions as a signal processing apparatus relating to audio processing and is used being gripped by a user or attached to something.

FIG. 1 schematically shows an appearance of the electronic apparatus 100 according to the first embodiment. The electronic apparatus 100 is an information processing apparatus having a display screen and, more specifically, is a slate (tablet) terminal, an e-book reader, a digital photoframe, or the like. The concept of the first embodiment can also be applied to PDAs, cell phones, etc. In FIG. 1, the positive directions of the X axis, Y axis, and the Z axis are indicated by arrows (the positive direction of the Z axis is the direction toward the front side).

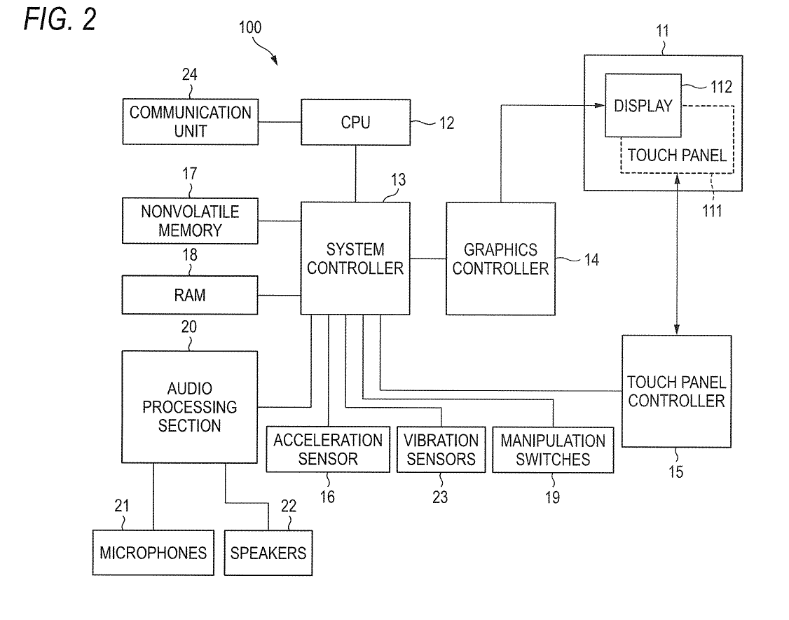

The electronic apparatus 100 has a thin, box-shaped body B and the screen of a display unit 11 is generally flush with the front surface of the body B. The display unit 11 is equipped with a touch panel 111 (see FIG. 2) for detecting a user touch position on the display screen. The bottom portion of the front surface of the body B is provided with manipulation switches 19 which allow a user to perform various manipulations and microphones 21 for picking up a user voice. The top portion of the front surface of the body B is provided with speakers 22 for sound output. The left and right (in the X-axis direction) side surfaces of the body B are provided with the vibration sensors 23 for detecting vibration that is caused by sound. Alternatively, the top and bottom (in the Y-axis direction) side surfaces of the body B may be provided with vibration sensors 23.

FIG. 2 is a block diagram showing an example hardware configuration of the electronic apparatus 100 according to the first embodiment. As shown in FIG. 2, the electronic apparatus 100 is equipped with, in addition to the above-described components, a CPU 12, a system controller 13, a graphics controller 14, a touch panel controller 15, an acceleration sensor 16, a nonvolatile memory 17, a RAM 18, an audio processing section 20, etc.

The display unit 11 is composed of a touch panel 11 and a display 112 such as an LCD (liquid crystal display) or an organic EL (electroluminescence) display. The touch panel 11 can detect a position (touch position) on the display screen where it has been touched by, for example, a finger of the user who is gripping the body B. This function of the touch panel 111 allows the display 112 to serve as what is called a touch screen.

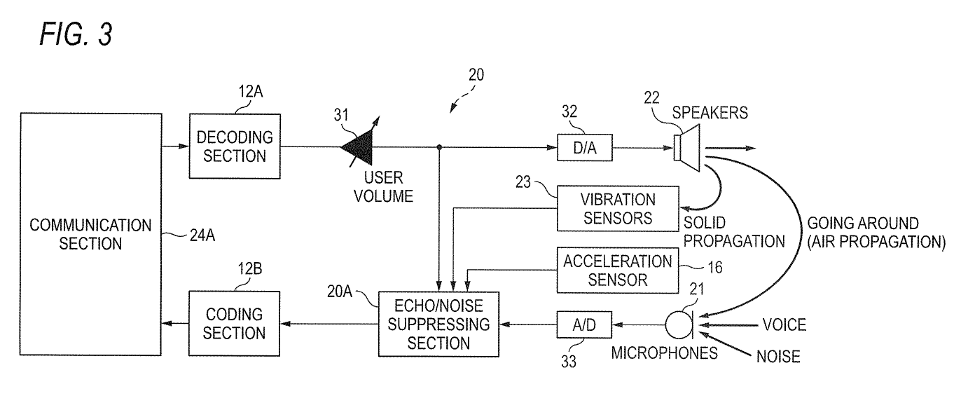

The CPU 12 is a central processor for controlling operations of the electronic apparatus 100, and controls individual components of the electronic apparatus 100 via the system controller 13. The CPU 12 realizes individual functional sections (described below with reference to FIG. 3) by running an operating system and various application programs that are loaded into the RAM 18 from the nonvolatile memory 17. As a main memory of the electronic apparatus 100, the RAM 18 provides a work area to be used by the CPU 12 in running programs.

The system controller 13 incorporates a memory controller for access-controlling the nonvolatile memory 17 and the RAM 18. The system controller 13 also has a function of performing a communication with the graphics controller 14.

The graphics controller 14 is a display controller for controlling the display 112 which is used as a display monitor of the electronic apparatus 100. The touch panel controller 15 controls the touch panel 111 and thereby acquires, from the touch panel 111, coordinate data that indicates a user touch position on the display screen of the display 112.

For example, the acceleration sensor 16 is a 6-axis acceleration sensor capable of detection of acceleration in and around the three directions shown in FIG. 1 (i.e., X, Y, and Z directions). The acceleration sensor 16 detects the direction and the magnitude of acceleration of the electronic apparatus 100 that is caused externally and outputs detection results to the CPU 12. More specifically, the acceleration sensor 16 outputs, to the CPU 12, acceleration a detection signal (inclination information) including information of acceleration-detected axes, a direction (in the case of rotation, a rotation angle), and a magnitude. A gyro sensor for detection of an angular velocity (rotation angle) may be integrated with the acceleration sensor 16.

Each vibration sensor 23 converts, inside itself, a signal generated by a vibration sensing element into a digital vibration signal xf[n] (n=1, 2, . . . ) and outputs the latter.

The audio processing section 20 performs audio processing such as digital conversion, noise elimination, and echo cancellation on audio signals supplied from the microphones 21, and outputs a resulting signal to the CPU 12. Furthermore, the audio processing section 20 performs audio processing such as voice synthesis under the control of the CPU 1, and supplies a generated audio signal to the speakers 22 to make a voice notification through the speakers 22.

FIG. 3 is a block diagram schematically showing a functional configuration for a voice call of the electronic apparatus 100 according to this embodiment. As shown in FIG. 3, the electronic apparatus 100 is equipped with hardware components which are the acceleration sensor 16, the microphones 21, the speakers 22, the vibration sensors 23, etc. and functional components for audio processing which is mainly performed by the audio processing section 20.

The audio processing section 20 is accompanied by a volume unit (user volume) 31 and equipped with a D/A converter 32.

The volume unit 31 adjusts the sound volume of an audio signal that is supplied from a communication section 24A via a decoding section 12A according to a manipulation amount of a volume adjustment switch.

The D/A converter 32 converts a digital audio signal xa[n] (n=1, 2, . . . ) as volume-adjusted by the volume unit 31 into an analog signal and outputs the latter to the speakers 22. The speakers 22, which are stereo speakers (alternatively, a monaural speaker is used), output a sound (reproduction sound) to the space in which the electronic apparatus 100 exists. The speakers 22 converts the analog signal supplied from the D/A converter 32 into physical vibration and thereby outputs a sound.

On the other hand, the audio processing section 20 is equipped with an A/D converter 33 which is connected to the microphones 21. The microphones 21, which are stereo microphones (alternatively, a monaural microphone is used), pick up a sound that is traveling through the space where the electronic apparatus 100 exists. The microphones 21 convert the picked-up sound into an analog picked-up sound signal z(t) (t: time) and outputs the latter to the A/D converter 33.

The A/D converter 33 converts the analog picked-up sound signal z(t) into a digital signal z[n] (n=1, 2, . . . ) and outputs the latter to an echo/noise suppressing section 20A which is a controller for suppressing echo and noise. A coding section 12B encodes a digital audio signal as noise-suppressed by the echo/noise suppressing section 20A and outputs a resulting signal to the communication section 24A. The decoding section 12A and the coding section 12B are functions of the CPU 12.

A configuration for acoustic echo elimination which, instead of performing a voice call, makes it possible to perform voice recognition while outputting a sound of a content such as a TV program or music is obtained by replacing the decoding section 12A with a memory (not shown) which is stored with contents of TV programs, music, etc. and replacing the coding section 12B with a voice recognizing section (not shown).

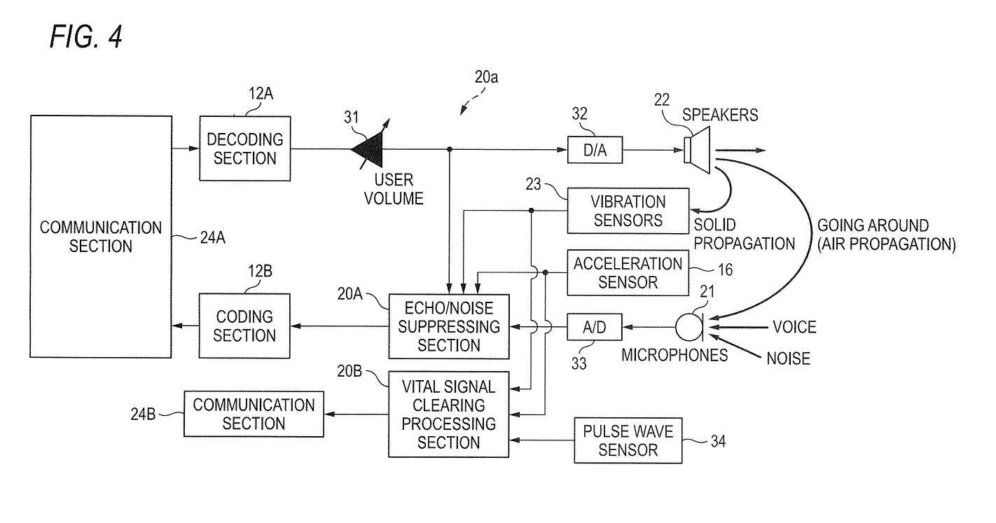

FIG. 4 is a block diagram showing another functional configuration for a voice call of the electronic apparatus 100 according to this embodiment. An audio processing section 20a performs health-case-related processing in addition to the processing performed by the audio processing section 20 shown in FIG. 3. The echo/noise suppressing section 20A and a vital signal clearing processing section 20B are functions of the audio processing section 20a. The communication section 24A and a communication section 24B are functions of the communication unit 24.

A pulse wave sensor 34 receives a human pulse wave and outputs a corresponding digital signal v[n] (n=1, 2, . . . ) to the vital signal clearing processing section 20B. The vital signal clearing processing section 20B performs vital signal clearing processing using an output of the acceleration sensor 16 (to eliminate noise that results from vibration caused by user motion also from the vital signal) and outputs of the vibration sensors 23 (to eliminate noise that results from vibration produced by the speakers 22 also from the vital signal), and outputs a resulting signal to the communication section 24B. For example, vital signal clearing processing section 20B suppresses noise in a vital signal v[n] by processing the vital signal v[n] with adaptive filter using outputs of the acceleration sensor 16 and the vibration sensors 23 as reference signals. Although in this example a pulse wave is employed as an example vital signal, any of other vital signals such as a pulse, a brain wave, an electrocardiogram, an electromyogram, a body temperature, a heartbeat, a skin surface temperature, a skin potential, a blood volume, a breathing rate, a blood saturation oxygen level (SpO2), and an O2Hb concentration may be used as a vital signal.

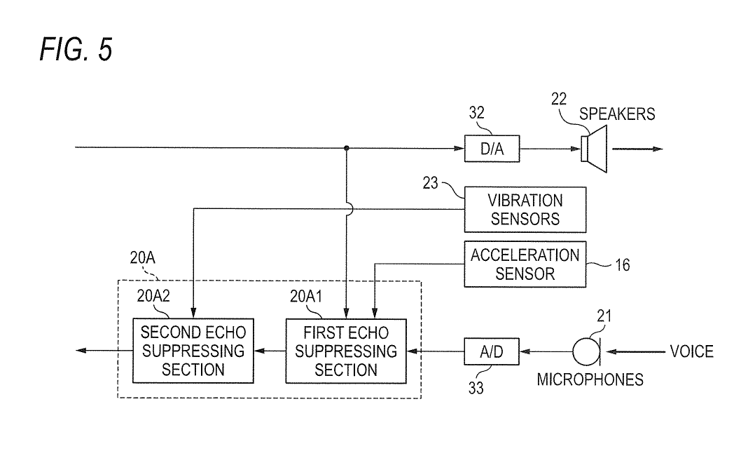

FIG. 5 shows the configuration of the echo/noise suppressing section 20A used in the embodiment. The echo/noise suppressing section 20A includes a first echo suppressing section 20A1 and a second echo suppressing section 20A2, whose configurations will be described below.

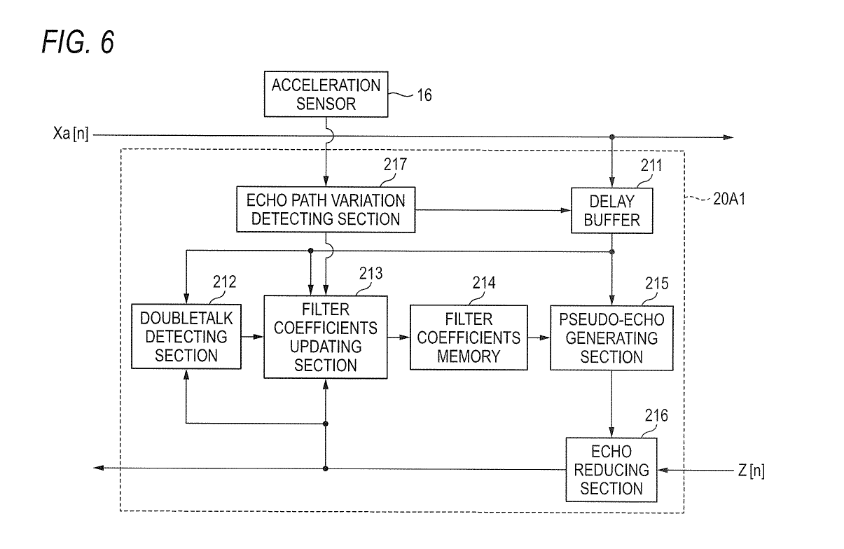

FIG. 6 is a block diagram showing a detailed configuration of the first echo suppressing section 20A1 used in the embodiment. The first echo suppressing section 20A1 is equipped with a delay buffer 211, a doubletalk detecting section 212, a filter coefficients updating section 213, a filter coefficients memory 214, a pseudo-echo generating section 215, an echo reducing section 216, and an echo path variation detecting section 217.

The delay buffer 211 adjusts the signal time difference so that the reading of a digital signal xa[n] is timed with introduction, through going-around, of a reproduction sound of the digital signal xa[n] into a digital signal z[n] of a picked-up sound signal. The doubletalk detecting section 212 detects doubletalk using xa[n] and z[n] (or an echo-reduced version of z[n]). The filter coefficients updating section 213 updates filter coefficients according to a detection result of the doubletalk detecting section 212. The filter coefficients updating section 213 does not update the filter coefficients if doubletalk is detected by the doubletalk detecting section 212. The filter coefficients memory 214 holds updated filter coefficients. The pseudo-echo generating section 215 generates pseudo-echo using the updated filter coefficients. The echo reducing section 216 reduces echo on the basis of the generated pseudo-echo. The echo path variation detecting section 217 controls the degree of update of the filter coefficients on the basis of an output of the acceleration sensor 16. If detecting an echo path variation, the echo path variation detecting section 217 increases the degree of update so that the filter coefficients are changed quickly to a large extent.

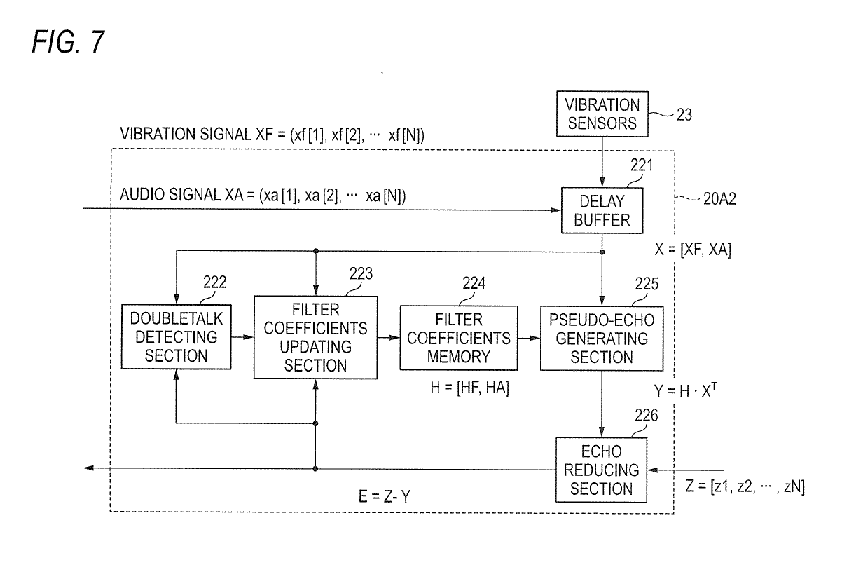

FIG. 7 is a block diagram showing a detailed configuration of the second echo suppressing section 20A2 used in the embodiment. The second echo suppressing section 20A2 is equipped with a delay buffer 221, a doubletalk detecting section 222, a filter coefficients updating section 223, a filter coefficients memory 224, a pseudo-echo generating section 225, and an echo reducing section 226.

The delay buffer 221 adjusts the signal time difference so that the reading of a digital signal xf[n] of vibration is timed with introduction, through going-around, of solid vibration caused by outputs of the speakers 22 into a digital signal z[n] of a picked-up sound signal. The doubletalk detecting section 222 detects doubletalk using the digital signal xf[n] of the vibration and the digital signal z[n] (or an echo-reduced version of z[n]). The filter coefficients updating section 223 updates filter coefficients according to a detection result of the doubletalk detecting section 222. The filter coefficients updating section 223 does not update the filter coefficients if doubletalk is detected by the doubletalk detecting section 222. The filter coefficients memory 224 holds updated filter coefficients. The pseudo-echo generating section 225 generates pseudo-echo using the updated filter coefficients. The echo reducing section 226 reduces echo on the basis of the generated pseudo-echo.

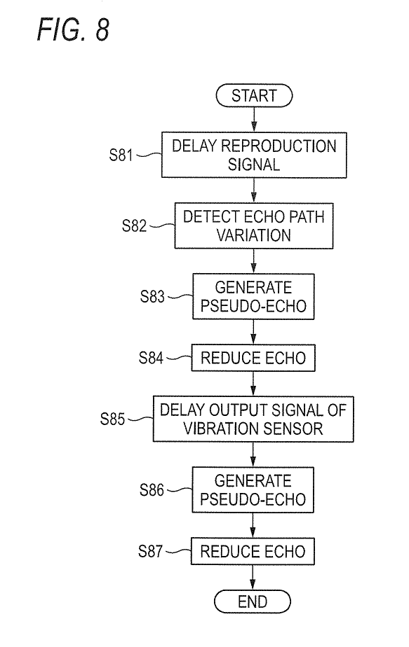

FIG. 8 is a flowchart of an example process which is executed by the echo/noise suppressing section 20A used in the embodiment. Steps S81-S84 are executed by the first echo suppressing section 20A1 and steps S85-S87 are executed by the second echo suppressing section 20A2.

Step S81: Delays a reproduction signal xa[n].

Step S82: Detects an echo path variation on the basis of an output of the acceleration sensor 16.

Step S83: Updates filter coefficients ha[n] according to an echo path variation, and generates pseudo-echo on the basis of a delayed version of the signal xa[n].

Step S84: Reduces echo in a picked-up sound signal z[n] using the pseudo echo, and outputs a resulting signal.

Step S85: Delays a signal xf[n] of the vibration sensors 23.

Step S86: Updates filter coefficients hf[n] on the basis of a delayed version of the signal xf[n], and generates pseudo-echo.

Step S87: Reduces echo in the picked-up sound signal z[n] using the pseudo echo, and outputs a resulting signal.

In this process, the filter coefficients ha[n] of the first echo suppressing section 20A1 are updated on the basis of an echo-reduced signal which is an output of the first echo suppressing section 20A1 and the filter coefficients hf[n] of the second echo suppressing section 20A2 are updated on the basis of an echo-reduced signal which is an output of the second echo suppressing section 20A2. That is, the first echo suppression and the second echo suppressed are performed sequentially.

### (Modification 1 of Embodiment 1)

Where as shown in FIG. 7 the transfer functions of the first echo suppressing section 20A1 and the second echo suppressing section 20A2 are represented by HA and HF (Z transform expressions), respectively, the transfer function H of the filter is expressed as H=(HF, HA) in vector form. If the reference signals reference signals are combined into (xf, xa) and Z-transform-expressed as (XF, XA) in vector form, the pseudo-echo signal Y is expressed as Y=H·A^{T} where T means transposition. The echo-reduced signal E is given by E=Z−Y where Z is the picked-up sound signal. The filter H=(HF, HA) is updated so that squared errors of E from the value without doubletalk are minimized. That is, when the filter coefficients are updated using the echo-reduced signals, HA and HF of the first echo suppressing section 20A1 and the second echo suppressing section 20A2 are updated in parallel using the single echo-reduced signal E.

### (Modification 2 of Embodiment 1)

A going-around component obtained in a state that the speakers 22 and the microphones 21 are suspended in a free space is space propagation sound, and A going-around component obtained in a state that the speakers 22 and the microphones 21 are mounted on the terminal body includes both of space propagation sound and solid propagation sound. Reproduction signals, vibration signals, and vibration going-around data are collected in advance in large numbers. An approximate relationship between the reproduction signal and the vibration going-around component (solid propagation sound) is obtained in advance in the form of a function so that the latter can be calculated from the former.

When the concept of the embodiment is applied to an actual product, a going-around component may be eliminated from a picked-up sound signal by estimating (calculating) a vibration going-around component using a reproduction digital signal and the above approximate function without mounting the vibration sensors 23. With this measure, it is not necessary to mount the vibration sensors 23, whereby a terminal can be produced at a low cost.

### Embodiment 2

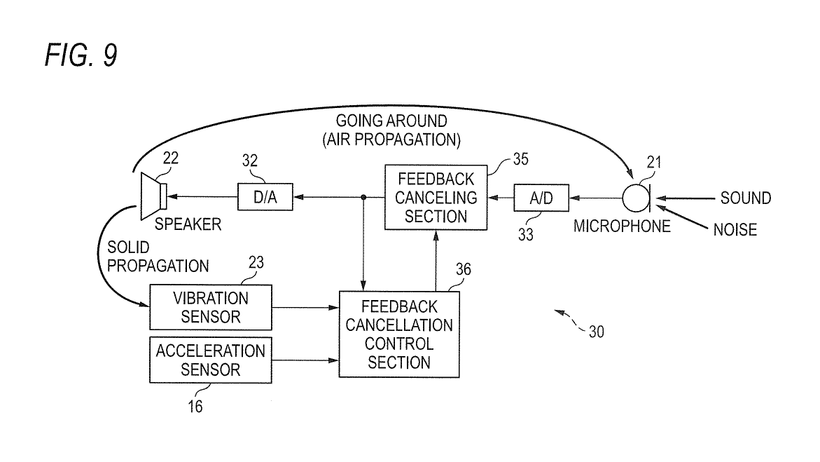

A second embodiment will be described below with reference to FIGS. 9-11. Components having the same or equivalent ones in the first embodiment will not be described in detail.

FIG. 9 is a block diagram schematically showing a functional configuration of an electronic apparatus (signal processing apparatus) 110 according to the second embodiment which is used as a hearing aid system (wearable apparatus). As shown in FIG. 9, the electronic apparatus 110 is equipped with hardware components which are an acceleration sensor 16, a microphone 21, a speaker 22, a vibration sensor 23, etc. and functional components for audio processing which is mainly performed by an audio processing section 30.

The audio processing section 30 has a D/A converter 32 and a feedback canceling section 35 and a feedback cancellation control section 36 which constitute a controller for suppressing noise due to vibration and acceleration. The D/A converter 32 converts a digital audio signal xa[n] as adjusted by the feedback canceling section 35 into an analog signal and outputs the latter to the speaker 22.

The speaker 22, which is a monaural speaker (alternatively, stereo speakers are used), emits a sound (reproduction sound) in the ear where it is inserted. The speaker 22 converts an analog signal which is received from the D/A converter 32 into physical vibration and outputs it as a sound.

The audio processing section 20 also has an A/D converter 33 which is connected to the microphone 21. The microphone 21, which is a monaural microphone (alternatively, stereo microphones are used), picks up a sound that is traveling through the space where the electronic apparatus 110 exists. The microphone 21 converts the picked-up sound into an analog picked-up sound signal and outputs the latter to the A/D converter 33.

The A/D converter 33 converts the analog picked-up sound signal into a digital signal z[n] and outputs the latter to the feedback canceling section 35. The feedback cancellation control section 36 controls the feedback canceling section 35 as the latter generates a noise-suppressed digital audio signal and outputs it to the D/A converter 32.

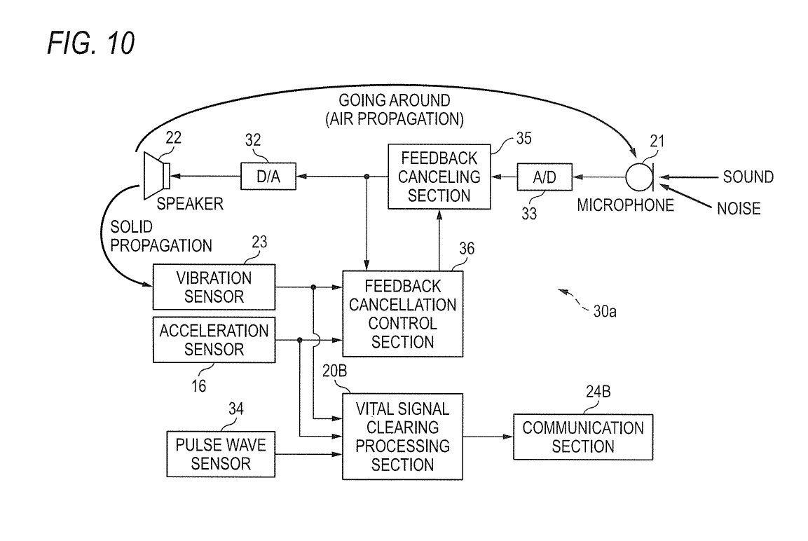

FIG. 10 is a block diagram schematically showing another functional configuration of the electronic apparatus 110 which is used as a hearing aid system. An audio processing section 30a performs health-case-related processing in addition to the processing performed by the audio processing section 30 shown in FIG. 9. The feedback canceling section 35, the feedback cancellation control section 36, and a vital signal clearing processing section 20B are functions of the audio processing section 30a.

A pulse wave sensor 34 receives a human pulse wave and outputs a resulting signal to the vital signal clearing processing section 20B. The vital signal clearing processing section 20B performs vital signal clearing processing using an output of the acceleration sensor 16 (to eliminate noise that results from vibration caused by user motion also from the vital signal) and an output of the vibration sensor 23 (to eliminate noise that results from vibration produced by the speaker 22 also from the vital signal), and outputs a resulting signal to a communication section 24B.

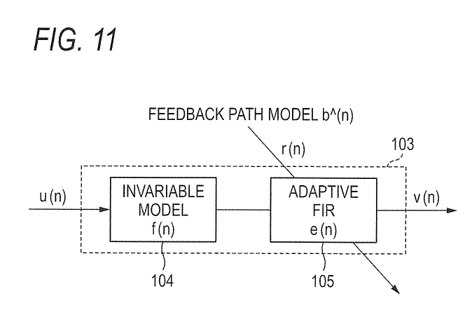

FIG. 11 shows a configuration which relates to the feedback canceling section 35 and the feedback cancellation control section 36 used in the second embodiment. The hearing aid system according to the second embodiment is equipped with an adaptive feedback canceller 103. The adaptive feedback canceller 103 is equipped with a fixed filter 104 which includes an invariable portion of a feedback path model and an adaptive filter 105 which includes a variable portion of the feedback path model.

As a result, the adaptive feedback canceller 103 can divide an impulse response b̂(n) of a feedback path model for a feedback path (going around) having an impulse response b(n) into an invariable feedback path model having an impulse response f(n) and a variable feedback path model having an impulse response e(n). Therefore, the adaptive feedback canceller 103 can trace a variation of the feedback path (b(n)) using the invariable feedback path model (f(n)) and the variable feedback path (e(n)). A variation in the feedback path (b(n)) is detected on the basis of the acceleration sensor 16, and, if a variation is detected, the degree of update of the filter coefficients of the variable feedback path (e(n)) is increased. Whereas conventionally a digital picked-up sound signal z[n] is used in a feedback canceller as a reference signal, in this embodiment a digital vibration signal xf[n] received from the vibration sensor 23 is also used in the feedback canceller 103 as a reference signal, whereby not only going-around (feedback) sound of space propagation but also going-around (feedback) sound of solid propagation is suppressed.

In this embodiment, the invariable feedback path model may be included in a finite impulse response (FIR) filter or an infinite impulse response (IIR) filter.

The embodiments provide an echo suppressing method which can suppress not only acoustic echo (air propagation sound) that is emitted from a speaker and goes around through an acoustic space and reaches a microphone but also going-around sound (solid propagation sound) from the speaker to the microphones due to apparatus body vibration which cannot be suppressed by any conventional method. As described above, in an environment in which a reproduction signal of a TV receiver, for example, is mixed with music or during a voice call of VoIP, for example, an echo component can be estimated stably and its introduction into a microphone as going-around sound can be suppressed stably. This allows increase of the reproduction sound volume.

### (Supplements to Embodiments)

(1) Echo due to vibration is eliminated using an output of a vibration sensor as a reference signal.

(2) Echo due to vibration is eliminated by an adaptive filter which uses an output of a vibration sensor as a reference signal.

(3) The echo suppression using the vibration sensor uses an algorithm which takes doubletalk into consideration but not an echo path variation.

(4) Where the acoustic echo canceller using an output signal of a speaker as a reference signal (first echo suppression) is also used, the echo canceller using the vibration sensor (second echo suppression) is disposed downstream of the former.

(5) An acceleration sensor is provided to detect an echo path variation, and the learning of the acoustic echo canceller is controlled according to a detected echo path variation.

(6) Where a vital information sensor is also used, speaker vibration causes noise introduction into the vital information sensor. In view of this, noise is eliminated from a vital signal using a vibration sensor.

The invention is not limited to the above embodiments themselves and may be practiced by variously modifying constituent elements without departing from the spirit and scope of the invention. Various inventive concepts may be conceived by properly combining plural constituent elements disclosed in each embodiment. For example, several ones of the constituent elements of each embodiment may be omitted, and constituent elements of different embodiments may be combined as appropriate.

1. A signal processing apparatus, comprising:
a speaker;
a vibration sensor configured to detect a vibration that is caused by a solid propagation of a sound from the speaker, and to output a reference signal based on the detected variation; and
a controller configured to perform a noise suppress control which suppresses a noise due to the vibration using the reference signal.

2. The apparatus of claim 1, further comprising:
an adaptive filter configured to suppress the noise due to the vibration using the reference signal.

3. The apparatus of claim 1, further comprising:
an acoustic echo canceller,
wherein the controller performs the noise suppress control for an output of the acoustic echo canceller.

4. The apparatus of claim 3, further comprising:
an acceleration sensor configured to detect an echo path variation,
wherein a learning operation of the acoustic echo canceller is controlled according to the detected echo path variation.

5. The apparatus of claim 1, further comprising:
a vital information sensor,
wherein the controller performs the noise suppress control for an output of the vital information sensor.

6. A signal processing method for a signal processing apparatus having a speaker, the method comprising:
detecting a vibration that is caused by a solid propagation of a sound from the speaker,
outputting a reference signal based on the detected vibration; and
performing a noise suppress control which suppresses a noise due to the vibration using the reference signal.
